(19) United States
(12) Patent Application Publication
(10) Pub. No.: US 2025/0368387 A1
(43) Pub. Date: Dec. 4, 2025

(54) PACKAGING STRUCTURE AND PROCESSING METHOD OF A PACKAGING STRUCTURE

(71) Applicant: Luxshare Precision Industry Company Limited, SHENZHEN (CN)

(72) Inventor: Xingfeng LI, SHENZHEN (CN)

(73) Assignee: Luxshare Precision Industry Company Limited, SHENZHEN (CN)

(21) Appl. No.: 19/221,266

(22) Filed: May 28, 2025

(30) Foreign Application Priority Data
May 29, 2024 (CN) 202410687451.0

(51) Int. Cl. B65D 5/50; B31B 50/26; B31B 100/00

(52) U.S. Cl. CPC B65D 5/5045; B31B 50/26; B31B 2100/00

(57) ABSTRACT

A packaging structure includes two first support plates and two second support plates. The two first support plates are parallel to each other and arranged at intervals. Each of the first support plates includes a first external support plate and a first internal support plate that fit against each other. The two second support plates are parallel to each other, arranged at intervals, and located between the two first support plates. Each of the second support plates includes a second external support plate and a second internal support plate that fit against each other. Two ends of a second external support plate abut against the plate surfaces of two first external support plates respectively. Two ends of a second internal support plate abut against the plate surfaces of two first internal support plates respectively.

### CROSS-REFERENCE TO RELATED APPLICATION(S)

This application claims the priority of a Chinese Patent Application No. 202410687451.0, filed on May 29, 2024, the disclosure of which is incorporated herein by reference in its entirety.

### TECHNICAL FIELD

The present application relates to the field of product packaging technology and, in particular, to a packaging structure and a processing method of a packaging structure.

### BACKGROUND

The existing electronic product is typically supported and cushioned by the cushioning liner in a packaging box to avoid an internal force impact during transportation. The cushioning liner is usually made of folded corrugated board. In the existing cushioning liner, in terms of structural modeling, the cushioning liner is a frame structure enclosed by four support plates. This kind of cushioning liner has a low structural strength and fails to withstand lateral external forces and cannot reliably protect electronic products.

### SUMMARY

The present application provides a packaging structure and a processing method of a packaging structure.

The present application adopts the technical solutions below.

The packaging structure includes two first support plates and two second support plates.

The two first support plates are parallel to each other and arranged at intervals. Each of the first support plates includes a first external support plate and a first internal support plate that fit against each other.

The two second support plates are parallel to each other, arranged at intervals, and located between the two first support plates. Each of the second support plates includes a second external support plate and a second internal support plate that fit against each other. The first external support plate and the second external support plate are perpendicular to each other. Two ends of the second external support plate abut against plate surfaces of two first external support plates respectively. The first internal support plate and the second internal support plate are perpendicular to each other. Two ends of the second internal support plate abut against plate surfaces of two first internal support plates respectively.

In some embodiments, a first external support plate includes a first external support inner plate, a first external support top plate, a first external support outer plate, and a first external support bottom plate connected in sequence.

The first external support inner plate and the first external support outer plate are parallel to each other and arranged at intervals. The plate surface of the first internal support plate fits against the plate surface of the first external support inner plate. The end of the second external support plate abuts against the plate surface of the first external support inner plate.

The first external support top plate and the first external support bottom plate are parallel to each other and arranged at intervals. The first internal support plate is connected to the first external support bottom plate.

In some embodiments, the first external support plate also includes a first external support insertion plate connected to the first external support inner plate. The first external support bottom plate is formed with a first insertion port. The first external support insertion plate is inserted into the first insertion port.

In some embodiments, the first internal support plate includes a first internal support outer plate, a first internal support top plate, and a first internal support inner plate connected in sequence.

The first external support bottom plate and the first internal support top plate are parallel to each other and arranged at intervals.

The first internal support outer plate and the first internal support inner plate are parallel to each other and arranged at intervals. The plate surface of the first internal support inner plate fits against the plate surface of the first external support inner plate. The end of the second internal support plate abuts against the plate surface of the first internal support outer plate.

In some embodiments, the first internal support plate also includes a first internal support insertion plate connected to the first internal support inner plate. The first external support bottom plate is formed with the first insertion port. The first internal support insertion plate is inserted into the first insertion port.

In some embodiments, the second external support plate includes a second external support inner plate, a second external support top plate, a second external support outer plate, and a second external support bottom plate connected in sequence.

The second external support inner plate and the second external support outer plate are parallel to each other and arranged at intervals. The plate surface of the second internal support plate fits against the plate surface of the second external support inner plate. The ends of the second external support inner plate abut against the plate surfaces of the first external support plates.

The second external support bottom plate and the second external support top plate are parallel to each other and arranged at intervals. The second internal support plate is connected to the second external support bottom plate.

In some embodiments, the second external support plate also includes a second external support insertion plate connected to the second external support inner plate. The second external support bottom plate is formed with a second insertion port. The second external support insertion plate is inserted into the second insertion port.

In some embodiments, the second internal support plate includes a second internal support outer plate, a second internal support top plate, and a second internal support inner plate connected in sequence.

The second external support bottom plate and the second internal support top plate are parallel to each other and arranged at intervals.

The second internal support outer plate and the second internal support inner plate are parallel to each other and arranged at intervals. The plate surface of the second internal support inner plate fits against the plate surface of the second external support inner plate. The ends of the second external support inner plate and the ends of the second internal support inner plate abut against the plate surfaces of the first internal support plates.

In some embodiments, the second internal support plate also includes a second internal support insertion plate connected to the second internal support inner plate. The second external support bottom plate is formed with the second insertion port. The second internal support insertion plate is inserted into the second insertion port.

The processing method of a packaging structure is used for folding and processing a to-be-folded plate into the preceding packaging structure.

The to-be-folded plate includes a first to-be-folded plate, a second to-be-folded plate, a third to-be-folded plate, a fourth to-be-folded plate, and a connecting plate connected in sequence.

The first to-be-folded plate and the third to-be-folded plate have the same structure and both include the first external support insertion plate, the first external support inner plate, the first external support top plate, the first external support outer plate, the first external support bottom plate, the first internal support outer plate, the first internal support top plate, the first internal support inner plate, and the first internal support insertion plate connected in sequence. The first external support bottom plate is formed with the first insertion port.

The second to-be-folded plate and the fourth to-be-folded plate have the same structure and both include the second external support insertion plate, the second external support inner plate, the second external support top plate, the second external support outer plate, the second external support bottom plate, the second internal support outer plate, the second internal support top plate, the second internal support inner plate, and the second internal support insertion plate connected in sequence. The second external support bottom plate is formed with the second insertion port. The second external support outer plate is connected to the first external support outer plate.

The method includes the steps below.

The connecting plate is connected to the first to-be-folded plate.

The first external support inner plate, the first external support top plate, the first external support outer plate, and the first external support bottom plate are bent 90° in sequence to enable an end of the first external support inner plate to abut against the plate surface of the first external support bottom plate and enable the first external support insertion plate to be inserted into the first insertion port to form the two first external support plates.

The first external support bottom plate, the first internal support outer plate, the first internal support top plate, and the first internal support inner plate are bent 90° in sequence to enable the plate surface of the first internal support inner plate to fit against the plate surface of the first external support inner plate, enable an end of the first internal support inner plate to abut against the plate surface of the first external support bottom plate, and enable the first internal support insertion plate to be inserted into the first insertion port to form the two first internal support plates.

The second external support inner plate, the second external support top plate, the second external support outer plate, and the second external support bottom plate are bent 90° in sequence to enable the ends of the second external support inner plate to abut against the plate surface of the second external support bottom plate and the plate surfaces of two first external support inner plates and enable the second external support insertion plate to be inserted into the second insertion port to form two second external support plates.

The second external support bottom plate, the second internal support outer plate, the second internal support top plate, and the second internal support inner plate are bent 90° in sequence to enable the plate surface of the second internal support inner plate to fit against the plate surface of the second external support inner plate, enable the ends of the second internal support inner plate to abut against the plate surface of the second external support bottom plate and the plate surfaces of two first internal support outer plates, enable an end of the second internal support outer plate to abut against the plate surfaces of two first internal support outer plates, and enable the second internal support insertion plate to be inserted into the second insertion port to form the two second internal support plates.

### BRIEF DESCRIPTION OF DRAWINGS

FIG. 1 is a view illustrating the structure of a to-be-folded plate according to one or more embodiments.

FIG. 2 is a view illustrating the structure of a packaging structure in an orientation according to one or more embodiments.

FIG. 3 is a view illustrating the structure of a packaging structure in another orientation according to one or more embodiments.

FIG. 4 is a view illustrating the structure of a packaging structure according to one or more embodiments without a second external support inner plate and a second external support top plate.

### DETAILED DESCRIPTION

Embodiments in accordance with the present application will now be described in detail below. Examples of the embodiments are illustrated in the drawings, where the same or similar reference numerals indicate the same or similar elements or components having the same or similar functions. The embodiments described hereinafter with reference to the drawings are exemplary.

In the description of the present application, unless otherwise expressly specified and limited, the term “connected to each other”, “connected”, or “secured” is to be construed in a broad sense, for example, as securely connected or detachably connected; mechanically connected or electrically connected; directly connected to each other or indirectly connected to each other via an intermediary; or internally connected between two elements or interactional relations between two elements. For those of ordinary skill in the art, specific meanings of the preceding terms in the present application may be construed according to specific circumstances.

In the description of the present application, unless otherwise expressly specified and limited, when a first feature is described as “on” or “below” a second feature, the first feature and the second feature may be in direct contact or be in contact via another feature between the two features instead of being in direct contact. Moreover, when the first feature is described as “on”, “above” or “over” the second feature, the first feature is right on, above or over the second feature, or the first feature is obliquely on, above or over the second feature, or the first feature is simply at a higher level than the second feature. When the first feature is described as “under”, “below” or “underneath” the second feature, the first feature is right under, below or underneath the second feature, or the first feature is obliquely under, below or underneath the second feature, or the first feature is simply at a lower level than the second feature.

Regarding structural modeling, the cushioning liner is a frame structure enclosed by four support plates. The support plates include internal support plates and external support plates that fit against each other. The four internal support plates abut against each other in sequence through internal abutment surfaces to form an internal frame. The internal frame is attached to an end of the electronic product. The four external support plates abut against each other in sequence through external abutment surfaces to form an external frame. The external frame sleeves the periphery of the electronic product.

In the existing cushioning liner, an internal abutment surface and an internal support plate form an angle of 45°, and an external abutment surface and an external support plate form an angle of 45°. As a result, the alignment accuracy of assembling the internal support plate and the external support plate is low, and the internal support plate and the external support plate are prone to deflection and misalignment. Finally, an internal frame and an external frame with low structural strength fail to withstand lateral external forces and cannot reliably protect electronic products.

The technical solutions of the present application are further described hereinafter in conjunction with the drawings and embodiments.

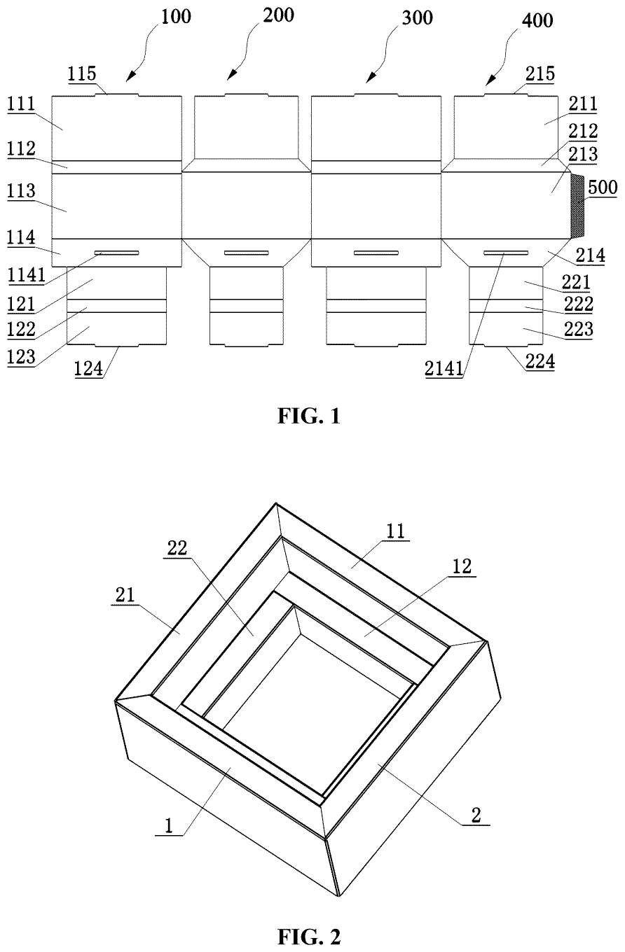

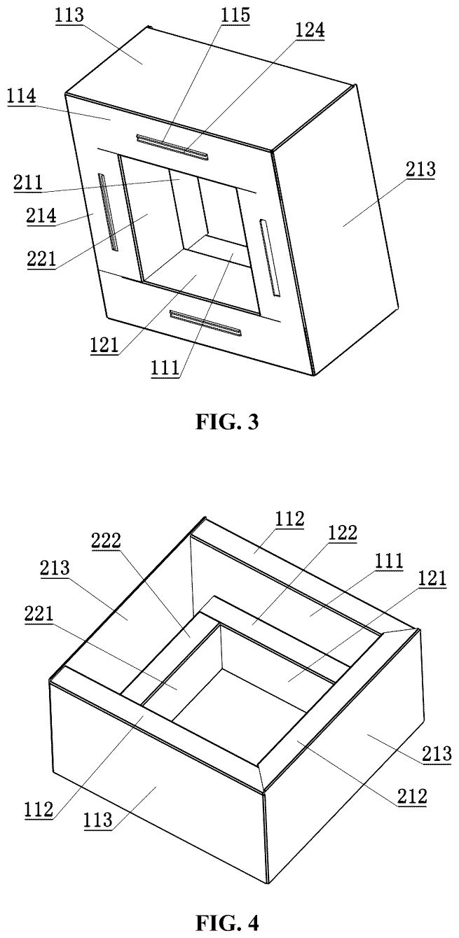

As shown in FIGS. 1 to 4, embodiments of the present application provide a packaging structure. The packaging structure includes two first support plates 1 and two second support plates 2. The two first support plates 1 are parallel to each other and arranged at intervals. Each of the first support plates 1 includes a first external support plate 11 and a first internal support plate 12 fitting against each other. The two second support plates 2 are parallel to each other, arranged at intervals, and located between the two first support plates 1. Each of the second support plates 2 includes a second external support plate 21 and a second internal support plate 22 fitting against each other. The first external support plate 11 and the second external support plate 21 are perpendicular to each other. The two ends of the second external support plate 21 abut against the plate surfaces of two first external support plates 11 respectively. The first internal support plate 12 and the second internal support plate 22 are perpendicular to each other. The two ends of the second internal support plate 22 abut against the plate surfaces of two first internal support plates 12 respectively.

In the present application, the first external support plate 11 and the second external support plate 21 are perpendicular to each other. The two ends of the second external support plate 21 abut against the plate surfaces of the two first external support plates 11 respectively. The first internal support plate 12 and the second internal support plate 22 are perpendicular to each other. The two ends of the second internal support plate 22 abut against the plate surfaces of the two first internal support plates 12 respectively. The mutually perpendicular ends and surfaces abut against each other, so that the alignment accuracy of assembling the first external support plates 11, the second external support plates 21, the first internal support plates 12, and the second internal support plates 22 is effectively improved, and deflection and misalignment are avoided. Finally, an internal frame and an external frame have higher structural strength and can withstand lateral external forces so that the reliable protection of a product is ensured.

Illustratively, the first external support plate 11 includes a first external support inner plate 111, a first external support top plate 112, a first external support outer plate 113, and a first external support bottom plate 114 connected in sequence. The first external support inner plate 111 and the first external support outer plate 113 are parallel to each other and arranged at intervals. The plate surface of the first internal support plate 12 fits against the plate surface of the first external support inner plate 111. The end of the second external support plate 21 abuts against the plate surface of the first external support inner plate 111. The first external support top plate 112 and the first external support bottom plate 114 are parallel to each other and arranged at intervals. The first internal support plate 12 is connected to the first external support bottom plate 114. With the preceding disposition, the first external support plate 11 can be processed simply and conveniently.

Illustratively, the first external support plate 11 also includes a first external support insertion plate 115 connected to the first external support inner plate 111. The first external support bottom plate 114 is formed with a first insertion port 1141. The first external support insertion plate 115 is inserted into the first insertion port 1141. With the preceding disposition, the first external support plate 11 can be positioned and fixed without adhesive or fasteners.

Illustratively, the first internal support plate 12 includes a first internal support outer plate 121, a first internal support top plate 122, and a first internal support inner plate 123 connected in sequence. The first external support bottom plate 114 and the first internal support top plate 122 are parallel to each other and arranged at intervals. The first internal support outer plate 121 and the first internal support inner plate 123 are parallel to each other and arranged at intervals. The plate surface of the first internal support inner plate 123 fits against the plate surface of the first external support inner plate 111. The end of the second internal support plate 22 abuts against the plate surface of the first internal support outer plate 121. With the preceding disposition, the first internal support plate 12 can be processed simply and conveniently, and the plate surface of the first internal support inner plate 123 fits against the plate surface of the first external support inner plate 111, thereby further improving the structural strength of the first support plates 1.

Illustratively, the first internal support plate 12 also includes a first internal support insertion plate 124 connected to the first internal support inner plate 123. The first internal support insertion plate 124 is inserted into a first insertion port 1141. With the preceding disposition, the first internal support plate 12 can be positioned and fixed without adhesive or fasteners.

In some embodiments, the first external support insertion plate 115 and the first internal support insertion plate 124 have the same structure and size. The first external support insertion plate 115 and the first internal support insertion plate 124 are respectively located at the middle position of the end of the first external support inner plate 111 and the middle position of the end of the first internal support inner plate 123, and share one first insertion port 1141. The first external support inner plate 111, the first external support top plate 112, the first external support outer plate 113, the first external support bottom plate 114, the first internal support outer plate 121, the first internal support top plate 122, and the first internal support inner plate 123 are all rectangular plates.

In other embodiments, each of the first external support insertion plate 115 and the first internal support insertion plate 124 may also be configured with one first insertion port 1141.

Illustratively, the second external support plate 21 includes a second external support inner plate 211, a second external support top plate 212, a second external support outer plate 213, and a second external support bottom plate 214 connected in sequence. The second external support inner plate 211 and the second external support outer plate 213 are parallel to each other and arranged at intervals. The plate surface of the second internal support plate 22 fits against the plate surface of the second external support inner plate 211. The ends of the second external support inner plate 211 abut against the plate surfaces of the first external support plates 11. The second external support bottom plate 214 and the second external support top plate 212 are parallel to each other and arranged at intervals. The second internal support plate 22 is connected to the second external support bottom plate 214. With the preceding disposition, the second external support plate 21 can be processed simply and conveniently.

Illustratively, the second external support plate 21 also includes a second external support insertion plate 215 connected to the second external support inner plate 211. The second external support bottom plate 214 is formed with a second insertion port 2141. The second external support insertion plate 215 is inserted into the second insertion port 2141. With the preceding disposition, the second external support plate 21 can be positioned and fixed without adhesive or fasteners.

Illustratively, the second internal support plate 22 includes a second internal support outer plate 221, a second internal support top plate 222, and a second internal support inner plate 223 connected in sequence. The second external support bottom plate 214 and the second internal support top plate 222 are parallel to each other and arranged at intervals. The second internal support outer plate 221 and the second internal support inner plate 223 are parallel to each other and arranged at intervals. The plate surface of the second internal support inner plate 223 fits against the plate surface of the second external support inner plate 211. The ends of the second external support inner plate 221 and the ends of the second internal support inner plate 223 abut against the plate surfaces of the first internal support plates 12. With the preceding disposition, the second internal support plate 22 can be processed simply and conveniently, and the plate surface of the second internal support inner plate 223 fits against the plate surface of the second external support inner plate 211, thereby further improving the structural strength of the second support plates 2.

Illustratively, the second internal support plate 22 also includes a second internal support insertion plate 224 connected to the second internal support inner plate 223. The second internal support insertion plate 224 is inserted into the second insertion port 2141. With the preceding disposition, the second internal support plate 22 can be positioned and fixed without adhesive or fasteners.

In some embodiments, the second external support insertion plate 215 and the second internal support insertion plate 224 have the same structure and size. The second external support insertion plate 215 and the second internal support insertion plate 224 are respectively located at the middle position of the end of the second external support inner plate 211 and the middle position of the end of the second internal support inner plate 223, and share one second insertion port 2141. The second external support inner plate 211, the second external support outer plate 213, the second internal support outer plate 221, the second internal support top plate 222, and the second internal support inner plate 223 are all rectangular plates. The second external support top plate 212 and the second external support bottom plate 214 are trapezoidal plates.

In other embodiments, each of the second external support insertion plate 215 and the second internal support insertion plate 224 may also be configured with one second insertion port 2141.

As shown in FIG. 1, the present application also provides a to-be-folded plate. The to-be-folded plate includes a first to-be-folded plate 100, a second to-be-folded plate 200, a third to-be-folded plate 300, a fourth to-be-folded plate 400, and a connecting plate 500 connected in sequence. The first to-be-folded plate 100 and the third to-be-folded plate 300 have the same structure and both include the first external support insertion plate 115, the first external support inner plate 111, the first external support top plate 112, the first external support outer plate 113, the first external support bottom plate 114, the first internal support outer plate 121, the first internal support top plate 122, the first internal support inner plate 123, and the first internal support insertion plate 124 connected in sequence. The first external support bottom plate 114 is formed with the first insertion port 1141. The second to-be-folded plate 200 and the fourth to-be-folded plate 400 have the same structure and both include the second external support insertion plate 215, the second external support inner plate 211, the second external support top plate 212, the second external support outer plate 213, the second external support bottom plate 214, the second internal support outer plate 221, the second internal support top plate 222, the second internal support inner plate 223, and the second internal support insertion plate 224 connected in sequence. The second external support bottom plate 214 is formed with the second insertion port 2141. The second external support outer plate 213 is connected to the first external support outer plate 113.

In some embodiments, the to-be-folded plate is a corrugated board. In other embodiments, the to-be-folded plate may be a plate of other structural forms or other materials, such as cardboard.

The present application also provides a processing method of a packaging structure used for folding and processing the to-be-folded plate into the preceding packaging structure. The method includes the steps below.

In step one, the connecting plate 500 is connected to the first to-be-folded plate 100.

In step two, the first external support inner plate 111, the first external support top plate 112, the first external support outer plate 113, and the first external support bottom plate 114 are bent 90° in sequence to enable an end of the first external support inner plate 111 to abut against the plate surface of the first external support bottom plate 114 and enable the first external support insertion plate 115 to be inserted into the first insertion port 1141 to form the two first external support plates 11.

In step three, the first external support bottom plate 114, the first internal support outer plate 121, the first internal support top plate 122, and the first internal support inner plate 123 are bent 90° in sequence to enable the plate surface of the first internal support inner plate 123 to fit against the plate surface of the first external support inner plate 111, enable an end of the first internal support inner plate 123 to abut against the plate surface of the first external support bottom plate 114, and enable the first internal support insertion plate 124 to be inserted into the first insertion port 1141 to form the two first internal support plates 12.

In step four, the second external support inner plate 211, the second external support top plate 212, the second external support outer plate 213, and the second external support bottom plate 214 are bent 90° in sequence to enable the ends of the second external support inner plate 211 to abut against the plate surface of the second external support bottom plate 214 and the plate surfaces of two first external support inner plates 111 and enable the second external support insertion plate 215 to be inserted into the second insertion port 2141 to form two second external support plates 21.

In step five, the second external support bottom plate 214, the second internal support outer plate 221, the second internal support top plate 222, and the second internal support inner plate 223 are bent 90° in sequence to enable the plate surface of the second internal support inner plate 223 to fit against the plate surface of the second external support inner plate 211, enable the ends of the second internal support inner plate 223 to abut against the plate surface of the second external support bottom plate 214 and the plate surfaces of two first internal support outer plates 121, enable an end of the second internal support outer plate 221 to abut against the plate surfaces of two first internal support outer plates 121, and enable the second internal support insertion plate 224 to be inserted into the second insertion port 2141 to form the two second internal support plates 22.

In the processing method of a packaging structure of the present application, the first external support plate 11 and the second external support plate 21 are perpendicular to each other. The two ends of the second external support plate 21 abut against the plate surfaces of the two first external support plates 11 respectively. The first internal support plate 12 and the second internal support plate 22 are perpendicular to each other. The two ends of the second internal support plate 22 abut against the plate surfaces of the two first internal support plates 12 respectively. The mutually perpendicular ends and surfaces abut against each other, so that the alignment accuracy of assembling the first external support plates 11, the second external support plates 21, the first internal support plates 12, and the second internal support plates 22 is effectively improved, and deflection and misalignment are avoided. Finally, the internal frame and the external frame have higher structural strength and can withstand lateral external forces so that the product is protected reliably.

Illustratively, the back adhesive is laid on the connecting plate 500, and the connecting plate 500 is connected to the first to-be-folded plate 100 through the back adhesive so that the operation is more convenient.

Illustratively, in step four, the second external support top plate 212 is lapped on the top of the first external support top plate 112 so as to limit the folded structure of the first external support plate 11.

In some embodiments, after step five, the method also includes the steps below.

In step six, two ends of the product are packaged in two packaging structures, so that the plate surface of the first external support inner plate 111 and the plate surface of the second external support inner plate 211 fit against the outer side surface of the product, and the plate surface of the first internal support top plate 122 and the plate surface of the second internal support top plate 222 fit against the end surface of the product.

In step seven, the product having two packaging structures is placed in an external box.

What is claimed is:

1. A packaging structure, comprising:
two first support plates parallel to each other and arranged at intervals, where each of the two first support plates comprises a first external support plate and a first internal support plate fitting against each other; and
two second support plates parallel to each other, arranged at intervals, and located between the two first support plates, wherein each of the two second support plates comprises a second external support plate and a second internal support plate fitting against each other;
wherein the first external support plate and the second external support plate are perpendicular to each other, and two ends of the second external support plate abut against plate surfaces of two first external support plates respectively; and
the first internal support plate and the second internal support plate are perpendicular to each other, and two ends of the second internal support plate abut against plate surfaces of two first internal support plates respectively.

2. The packaging structure according to claim 1, wherein the first external support plate comprises a first external support inner plate, a first external support top plate, a first external support outer plate, and a first external support bottom plate connected in sequence;
the first external support inner plate and the first external support outer plate are parallel to each other and arranged at intervals, a plate surface of the first internal support plate fits against a plate surface of the first external support inner plate, and an end of the second external support plate abuts against the plate surface of the first external support inner plate; and
the first external support top plate and the first external support bottom plate are parallel to each other and arranged at intervals, and the first internal support plate is connected to the first external support bottom plate.

3. The packaging structure according to claim 2, wherein the first external support plate further comprises a first external support insertion plate connected to the first external support inner plate, the first external support bottom plate is formed with a first insertion port, and the first external support insertion plate is inserted into the first insertion port.

4. The packaging structure according to claim 2, wherein the first internal support plate comprises a first internal support outer plate, a first internal support top plate, and a first internal support inner plate connected in sequence;
the first external support bottom plate and the first internal support top plate are parallel to each other and arranged at intervals; and
the first internal support outer plate and the first internal support inner plate are parallel to each other and arranged at intervals, a plate surface of the first internal support inner plate fits against the plate surface of the first external support inner plate, and an end of the second internal support plate abuts against a plate surface of the first internal support outer plate.

5. The packaging structure according to claim 3, wherein the first internal support plate comprises a first internal support outer plate, a first internal support top plate, and a first internal support inner plate connected in sequence;
the first external support bottom plate and the first internal support top plate are parallel to each other and arranged at intervals; and
the first internal support outer plate and the first internal support inner plate are parallel to each other and arranged at intervals, a plate surface of the first internal support inner plate fits against the plate surface of the first external support inner plate, and an end of the second internal support plate abuts against a plate surface of the first internal support outer plate.

6. The packaging structure according to claim 4, wherein the first internal support plate further comprises a first internal support insertion plate connected to the first internal support inner plate, the first external support bottom plate is formed with a first insertion port, and the first internal support insertion plate is inserted into the first insertion port.

7. The packaging structure according to claim 5, wherein the first internal support plate further comprises a first internal support insertion plate connected to the first internal support inner plate, the first external support bottom plate is formed with a first insertion port, and the first internal support insertion plate is inserted into the first insertion port.

8. The packaging structure according to claim 7, wherein the second external support plate comprises a second external support inner plate, a second external support top plate, a second external support outer plate, and a second external support bottom plate connected in sequence;
the second external support inner plate and the second external support outer plate are parallel to each other and arranged at intervals, a plate surface of the second internal support plate fits against a plate surface of the second external support inner plate, and ends of the second external support inner plate abut against the plate surfaces of the first external support plates; and
the second external support bottom plate and the second external support top plate are parallel to each other and arranged at intervals, and the second internal support plate is connected to the second external support bottom plate.

9. The packaging structure according to claim 1, wherein the second external support plate comprises a second external support inner plate, a second external support top plate, a second external support outer plate, and a second external support bottom plate connected in sequence;
the second external support inner plate and the second external support outer plate are parallel to each other and arranged at intervals, a plate surface of the second internal support plate fits against a plate surface of the second external support inner plate, and ends of the second external support inner plate abut against the plate surfaces of the first external support plates; and
the second external support bottom plate and the second external support top plate are parallel to each other and arranged at intervals, and the second internal support plate is connected to the second external support bottom plate.

10. The packaging structure according to claim 9, wherein the second external support plate further comprises a second external support insertion plate connected to the second external support inner plate, the second external support bottom plate is formed with a second insertion port, and the second external support insertion plate is inserted into the second insertion port.

11. The packaging structure according to claim 9, wherein the second internal support plate comprises a second internal support outer plate, a second internal support top plate, and a second internal support inner plate connected in sequence;
the second external support bottom plate and the second internal support top plate are parallel to each other and arranged at intervals; and
the second internal support outer plate and the second internal support inner plate are parallel to each other and arranged at intervals, a plate surface of the second internal support inner plate fits against the plate surface of the second external support inner plate, and the ends of the second external support inner plate and ends of the second internal support inner plate abut against the plate surfaces of the first internal support plates.

12. The packaging structure according to claim 10, wherein the second internal support plate comprises a second internal support outer plate, a second internal support top plate, and a second internal support inner plate connected in sequence;
the second external support bottom plate and the second internal support top plate are parallel to each other and arranged at intervals; and
the second internal support outer plate and the second internal support inner plate are parallel to each other and arranged at intervals, a plate surface of the second internal support inner plate fits against the plate surface of the second external support inner plate, and the ends of the second external support inner plate and ends of the second internal support inner plate abut against the plate surfaces of the first internal support plates.

13. The packaging structure according to claim 11, wherein the second internal support plate further comprises a second internal support insertion plate connected to the second internal support inner plate, the second external support bottom plate is formed with a second insertion port, and the second internal support insertion plate is inserted into the second insertion port.

14. The packaging structure according to claim 12, wherein the second internal support plate further comprises a second internal support insertion plate connected to the second internal support inner plate, the second external support bottom plate is formed with a second insertion port, and the second internal support insertion plate is inserted into the second insertion port.

15. The packaging structure according to claim 7, wherein the packaging structure comprises a first to-be-folded plate, a second to-be-folded plate, a third to-be-folded plate, a fourth to-be-folded plate, and a connecting plate connected in sequence, and the connecting plate is connected to the first to-be-folded plate through the back adhesive; and
the first to-be-folded plate and the third to-be-folded plate have the same structure and both comprise the first external support insertion plate, the first external support inner plate, the first external support top plate, the first external support outer plate, the first external support bottom plate, the first internal support outer plate, the first internal support top plate, the first internal support inner plate, and the first internal support insertion plate connected in sequence. The first external support bottom plate is formed with the first insertion port.

16. A processing method of a packaging structure, used for folding and processing a to-be-folded plate into the packaging structure according to claim 1, wherein
the to-be-folded plate comprises a first to-be-folded plate, a second to-be-folded plate, a third to-be-folded plate, a fourth to-be-folded plate, and a connecting plate connected in sequence;
the first to-be-folded plate and the third to-be-folded plate have a same structure and both comprise a first external support insertion plate, a first external support inner plate, a first external support top plate, a first external support outer plate, a first external support bottom plate, a first internal support outer plate, a first internal support top plate, a first internal support inner plate, and a first internal support insertion plate connected in sequence; and the first external support bottom plate is formed with a first insertion port;
the second to-be-folded plate and the fourth to-be-folded plate have a same structure and both comprise a second external support insertion plate, a second external support inner plate, a second external support top plate, a second external support outer plate, a second external support bottom plate, a second internal support outer plate, a second internal support top plate, a second internal support inner plate, and a second internal support insertion plate connected in sequence; the second external support bottom plate is formed with a second insertion port; and the second external support outer plate is connected to the first external support outer plate; and
the method comprises:
connecting the connecting plate to the first to-be-folded plate;
bending the first external support inner plate, the first external support top plate, the first external support outer plate, and the first external support bottom plate 90° in sequence to enable an end of the first external support inner plate to abut against a plate surface of the first external support bottom plate and enable the first external support insertion plate to be inserted into the first insertion port to form the two first external support plates;
bending the first external support bottom plate, the first internal support outer plate, the first internal support top plate, and the first internal support inner plate 90° in sequence to enable a plate surface of the first internal support inner plate to fit against a plate surface of the first external support inner plate, enable an end of the first internal support inner plate to abut against the plate surface of the first external support bottom plate, and enable the first internal support insertion plate to be inserted into the first insertion port to form the two first internal support plates;
bending the second external support inner plate, the second external support top plate, the second external support outer plate, and the second external support bottom plate 90° in sequence to enable ends of the second external support inner plate to abut against a plate surface of the second external support bottom plate and plate surfaces of two first external support inner plates and enable the second external support insertion plate to be inserted into the second insertion port to form the two second external support plates; and
bending the second external support bottom plate, the second internal support outer plate, the second internal support top plate, and the second internal support inner plate 90° in sequence to enable a plate surface of the second internal support inner plate to fit against a plate surface of the second external support inner plate, enable ends of the second internal support inner plate to abut against the plate surface of the second external support bottom plate and plate surfaces of two first internal support outer plates, enable an end of the second internal support outer plate to abut against the plate surfaces of the two first internal support outer plates, and enable the second internal support insertion plate to be inserted into the second insertion port to form the two second internal support plates.

17. The processing method of a packaging structure according to claim 16, wherein the second external support top plate is lapped on the top of the first external support top plate so as to limit the folded structure of the first external support plate.

18. The processing method of a packaging structure according to claim 16, wherein after bending the second external support bottom plate, the second internal support outer plate, the second internal support top plate, and the second internal support inner plate 90° in sequence, the method further comprises:
packing two ends of a product in two packaging structures so that the plate surface of the first external support inner plate and the plate surface of the second external support inner plate fit against the outer side surface of the product, and the plate surface of the first internal support top plate and the plate surface of the second internal support top plate fit against the end surface of the product; and
placing the product having two packaging structures in an external box.

19. The processing method of a packaging structure according to claim 16, wherein the first external support plate comprises a first external support inner plate, a first external support top plate, a first external support outer plate, and a first external support bottom plate connected in sequence;
the first external support inner plate and the first external support outer plate are parallel to each other and arranged at intervals, a plate surface of the first internal support plate fits against a plate surface of the first external support inner plate, and an end of the second external support plate abuts against the plate surface of the first external support inner plate; and
the first external support top plate and the first external support bottom plate are parallel to each other and arranged at intervals, and the first internal support plate is connected to the first external support bottom plate.

20. The processing method of a packaging structure according to claim 19, wherein the first external support plate further comprises a first external support insertion plate connected to the first external support inner plate, the first external support bottom plate is formed with a first insertion port, and the first external support insertion plate is inserted into the first insertion port.
